(19) United States
(12) Patent Application Publication
(10) Pub. No.: US 2008/0012931 A1
(43) Pub. Date: Jan. 17, 2008

(54) Vacuum hold down system

(75) Inventors: Xavier Gros, Barcelona (ES); Xavier Gasso Puchal, Barcelona (ES); Francisco Javier Perez, Sant Cugat del Valles (ES); Jesus Garcia, Terrassa (ES)

Correspondence Address: HEWLETT-PACKARD COMPANY;Intellectual Property Administration, P.O. Box 272400, Fort Collins, CO, 80527-2400, US

(73) Assignee: Hewlett-Packard Development Company, L.P.

(21) Appl. No.: 11/821,198

(22) Filed: Jun. 22, 2007

Related U.S. Application Data
(62) Division of application No. 10/513,052, filed on Oct. 29, 2004.

(30) Foreign Application Priority Data
Apr. 30, 2002 (GB) 0209922.4

(51) Int. Cl. B41J 13/22; B23P 17/00

(52) U.S. Cl. 347/220; 269/21; 29/890.09; 29/896.6; 346/138

(57) ABSTRACT

A hold down apparatus for use in a hardcopy device (20) comprising a first surface adapted to support a sheet of print media (74) thereon and a vacuum guide arranged to support a partial vacuum, the first surface having a plurality of apertures therein in fluid communication with the vacuum guide via a porous or labyrinthine flow restraint (82a, 82b), the apparatus being arranged such that downstream of the apertures, unimpeded vacuum flow between the plurality of apertures is substantially prevented.

### FIELD OF THE INVENTION

The present invention relates generally to vacuum hold down devices, and more particularly, but not exclusively, to a hard copy apparatus adapted to hold down print media using a vacuum force.

### BACKGROUND OF THE INVENTION

It is known to use a vacuum induced force to adhere a sheet of flexible material to a surface, for example to hold a sheet of print media temporarily to a platen of a printing device. In a printing device, such as a copier or a computer printer, a platen may be used either to transport print media, such as paper, to an internal printing station or to hold the print media at the printing station while images are formed, or both. Such vacuum hold down systems are a relatively common, since they allow improvements in print quality to be made whilst being economical to implement commercially.

One general problem in such vacuum systems is the management of different sized print media. When using print media smaller than the vacuum field in the platen surface, some vacuum holes, or ports, around the edges of a sheet remain exposed or open. This causes changes of the flow forces at other vacuum ports and a loss of holding pressure at covered ports. If too many vacuum ports are exposed, the vacuum pressure acting on the print media may be reduced to a level that is inadequate. Thus, a sheet of print media that is smaller than the total vacuum field may not be not firmly adhered to the surface of the platen. It has been found in practice that the average vacuum pressure acting on a sheet may be reduced by up to as much as much as 50% where as little as 13% of the vacuum ports are open. This reduction in average vacuum pressure often necessitates the provision of powerful and costly vacuum systems, which are able to provide adequate average vacuum pressure even for print media sizes that are significantly smaller than the vacuum field.

The art of inkjet technology is relatively well developed. Commercial products such as computer printers, graphics plotters, copiers, and facsimile machines employ ink-jet technology for producing hard copy. The basics of this technology are disclosed, for example, in various articles in the Hewlett-Packard Journal, Vol. 36, No. 5 (May 1985), Vol. 39, No. 4 (August 1988), Vol. 39, No. 5 (October 1988), Vol. 43, No. 4 (August 1992), Vol. 43, No. 6 (December 1992) and Vol. 45, No. 1 (February 1994) editions. Ink-jet devices are also described by W. J. Lloyd and H. T. Taub in Output Hardcopy [sic] Devices, chapter 13 (Ed. R. C. Durbeck and S. Sherr, Academic Press, San Diego, 1988).

When vacuum systems are applied to inkjet printing, the problem of exposed vacuum ports can cause further problems. Firstly, in an inkjet environment, air-flow through open vacuum ports located around the periphery of the print media may affect ink drop trajectories. This may result in misprints or artefacts in the final image as a result of errors in drop placement Furthermore, ink drops may be sucked into the vacuum system through the open vacuum ports. This ink may, in some cases, be deposited on the underside of the print media sheet, resulting in an undesirable smearing on the reverse side of a printed image and the presence of ink on the print platen.

Secondly, when print media absorbs water contained in the ink deposited upon it, it expands. If the degree of expansion is sufficient, a phenomenon known as “cockle” may occur, where the print media develops an undulated profile. This has the effect of altering the distance between the nozzles of the inkjet pens and the surface of the print media being printed upon; this is often known as the “pen-to-paper spacing”. A variable pen-to-paper spacing, such as is caused by cockle, may cause undesirable artefacts in the printed output However, in severe cases of cockle, the nozzles of the inkjet pens may crash against the print medium, ruining the printed output and possibly damaging the inkjet pens. It has been found that by controlling the vacuum force acting on a sheet of print media, such cockle may be reduced and so this problem may be greatly alleviated. However, where there are exposed vacuum ports, this problem may persist.

One known method of addressing the problem of exposed vacuum ports is employed in the Hewlett-Packard DesignJet 500 and 800 series printers. This method reduces the effect that any exposed vacuum ports have on the covered vacuum ports by using baffles, located under the platen, between the exposed vacuum ports and the covered vacuum ports. Thus, a series of baffles aligned in the media feed direction are positioned under the platen. The positions of the baffles along the platen (i.e. perpendicular to the media feed direction) are selected to correspond to common print media widths. Although this solution is relatively inexpensive and readily implemented, it suffers from a number of drawbacks. In such a system, the number and the positions of the baffles can be optimised for only a limited number of print media sizes. Thus, although this solution works relatively well for print media having widths corresponding the baffle positions, it works less well for print media having intermediate widths. Furthermore, inkjet printers generally function by incrementally transporting print media over a platen (and its associated vacuum field) and printing only on that portion of the print media located over the platen. Thus, when a sheet of print media arrives at, or leaves the vacuum field, the print media covers only a proportion of the vacuum ports, leaving the remainder exposed. In such instances the problem of open vacuum ports is prominent, irrespective of the width of the print media being used.

Other known solutions to the problem of exposed vacuum ports generally rely on the manual or automatic switching of operational functions to adjust the vacuum field to match the size of the print media in currently being used. However, such solutions have been found to be relatively complex to implement or undesirably operator dependent. Therefore, it would be desirable to provide a vacuum hold down device or system that overcomes one or more of the disadvantages associated with the prior art.

### SUMMARY OF THE INVENTION

According to one aspect of the invention there is provided a hold down apparatus for use in a hardcopy device comprising a first surface adapted to support a sheet of print media thereon and a vacuum guide arranged to support a partial vacuum, the first surface having a plurality of apertures therein in fluid communication with the vacuum guide via at least one porous or labyrinthine flow restraint arranged to impede vacuum flow, the at least one flow restraint further arranged such that downstream of the apertures, unimpeded vacuum flow between the plurality of apertures is substantially prevented.

Advantageously, such use of flow restraints in embodiments of the present invention allows the vacuum flow passing through areas of the platen not covered by print media to be significantly reduced. Furthermore, the effect of an aperture of the platen not being covered by print media may have a reduced effect, relative to prior art systems, on the vacuum level acting on the print media via a neighbouring covered aperture. Thus, vacuum waste may be reduced and the vacuum force acting on a sheet of print media by the remainder of the platen may be maintained at a higher level than would otherwise be the case. Therefore, the vacuum power requirements for a given system may be reduced.

Furthermore, by reducing the vacuum flow through exposed nobles, the vacuum flow noise generated in embodiments of the present invention may also be reduced. In prior art devices this can be a particular problem when the platen is almost entirely, but not wholly, covered by print media. In such situations, it has been found by that air-flows of up to 100 Km/h can be experienced in certain inkjet printing devices, giving rise to considerable levels of noise.

One test of the effectiveness of the a hold down apparatus for use in an inkjet environment is to measure the “height of influence” of a hold down system for a given operational set up. By the height of influence, it is meant the height above a sheet of print media on to which an ink drop is to be printed, that the trajectory of the drop may be influenced by the flow of air through exposed vacuum ports. It will be understood that it is generally desirable to minimise the “height of influence”, since if the trajectories of printed ink drops are altered, printing defects may arise. In the case of one embodiment of the present invention, the “height of influence” was measured to have decreased by a factor of 20 relative to corresponding prior art devices. It will be understood that any errors in drop position may be correspondingly reduced.

The average vacuum pressure acting on a sheet of print media in embodiments of the present invention may also vary less and in a more linear manner, as the proportion of the platen covered by the sheet varies, than is the case with prior art systems. This means that it may be easier to predict the required vacuum force for a given print job. This benefit may be of particular value where the printer device automatically determines the vacuum power that is required for a given print job.

By the suitable selection of the impedance of the flow restraint(s), the average vacuum force acting on a sheet of print media that completely covers the platen of an embodiment of the invention may be substantially equal to that which would act on the sheet if the flow restraint were removed. However, other impedances for the flow restraints may be chosen giving rise to differing average vacuum forces. In certain embodiments, the flow restraints serve to reduce the vacuum flow through the platen holes by a factor of between 1 and 20. In other embodiments, the flow restraints serve to reduce the vacuum flow through the platen holes by a factor of approximately 10.

In certain embodiments, the flow restraint material is a porous open cell foam material such as Porex™. The pore size in certain embodiments may range between 60 and 90 μm in diameter and have a thickness in the direction of the vacuum flow of approximately 3 to 5 millimetres. However, in other embodiments, significant benefit may be achieved using flow restraints having thicknesses ranging between 1 and 20 millimetres. Additionally, significant benefit may be achieved using porous material having pore sizes, in use, of between 20 and 200 μm in diameter. Different systems will have different desired average vacuum pressures, which in many cases will require further deviation from the porosity and thickness values given above.

Because such flow restraints may be positioned across the entire platen area, embodiments of the invention may be used to efficiently hold down a great range of media sizes. This may be the case without the need for manual or automatic adjustment of the size of the vacuum hold down area, to match the size of print media being used. Thus, embodiments of the present invention may be structurally simple and so inexpensive to use and easy to operate. As a corollary of this feature, embodiments of the invention may be used to efficiently hold down a media as it enters or leaves the print zone or platen, whilst only a proportion of the vacuum ports are covered. In this manner, embodiments of the invention act to solve the problem of uncovered vacuum ports in dual axes. That is to say along both the length and the width of the platen of a printer. Thus, the probability and severity of cockle, cockle related printing defects and head crashed may also be greatly reduced.

In one embodiment of the invention, a porous platen is employed, which serves to support the print media during a printing operation, as well as transmitting the vacuum force to the supported print media and introducing an impedance to the vacuum flow. In this embodiment, the vacuum pressure which is applied to a supported sheet may be very evenly distributed across the area of the sheet, due to the tight packing of the pores in the upper surface of the platen. This characteristic of the present embodiment may be useful in holding down the edges of a print media sheets. This may be independent of the size of the media sheets. In contrast, the edges of media sheets may tend to lift off a conventional platen. Due to the relatively dispersed spacing between conventional platen vacuum ports, it may occur that no or insufficient ports are located at the exact position required to adequately hold down the edges of certain sized of media sheet.

According to another embodiment of the invention, a conventional platen may be used with one or more associated flow restraints. This may be in the form of one or more sheets of flow restraint material that is effectively contiguous with, for example bonded to, the bottom surface of the platen. As an alternative, individual flow restraints may be associated with each vacuum port; for example, by embedding flow restraint material in the individual vacuum channels of a platen.

By using flow restraints formed from a compressible material, such as a foam material, the impedance to flow may be increased by compressing the material; thus reducing the average pore size of the flow restraint. In this manner, an optimised impedance may be found, for example in situ, for a given set of conditions using a simple experimental procedure.

The invention also extends to the method of manufacturing the apparatus and replacement porous flow restraints and platens for use in the apparatus.

Other features and advantages of the present invention will become apparent from the following explanation and the accompanying drawings.

### BRIEF DESCRIPTION OF THE DRAWINGS

For a better understanding of the invention and to show how it may be carried into effect, there will now be described by way of example only, specific embodiments, methods and processes according to the present invention with reference to the accompanying drawings in which:

FIG. 1 shows a perspective view of a large format inkjet printer incorporating the features of a first embodiment of the present invention;

FIG. 2 is a perspective view of a platen and vacuum beam of the first embodiment of the present invention;

FIG. 3 is a scrap, plan view of the platen shown in FIG. 2;

FIG. 4a is a partial, exploded view of the platen and vacuum beam shown in FIG. 2, illustrating the positioning of the flow restraints of the first embodiment;

FIG. 4b illustrates a partial, simplified elevation of the vacuum beam assembly shown in FIG. 4a in its assembled state;

FIG. 5 is a graph showing the measured relationship between average vacuum pressure acting on a sheet of print media and the percentage coverage of the platen by the sheet for an embodiment of the invention; and,

FIG. 6 is a perspective view of a platen and vacuum beam according to a second embodiment of the invention.

### DETAILED DESCRIPTION OF THE BEST MODE FOR CARRYING OUT THE INVENTION

There will now be described examples of the best mode contemplated by the inventors for carrying out the invention.

### First Embodiment

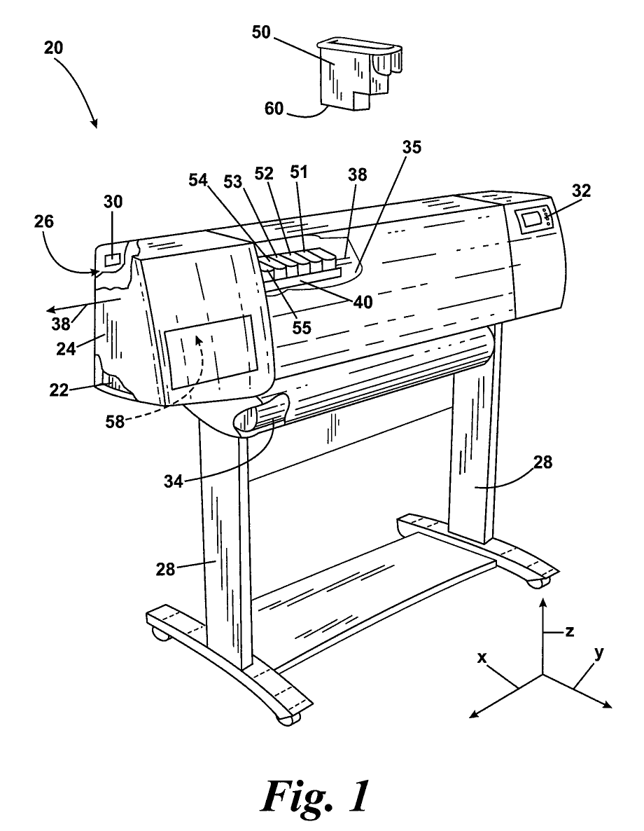

FIG. 1 illustrates an inkjet printing mechanism, here shown as a large format inkjet printer 20, comprising a vacuum hold down system according to the first embodiment of the present invention and which may be used for printing conventional engineering and architectural drawings, as well as high quality poster-sized images. Commonly assigned U.S. Pat. No. 5,835,108, entitled “Calibration technique for misdirected inkjet printhead nozzles”, describes an exemplary printing system suitable for use with the present invention and is hereby incorporated by reference in its entirety.

Although printers vary from model to model, the typical inkjet printer 20 includes a chassis 22 surrounded by a casing 24, typically of a plastic material, together forming a print assembly portion 26 of the printer 20. Although the print assembly portion 26 may be supported by a desk or tabletop, a pair of leg assemblies 28 is used in this example. The printer 20 also has a printer controller, illustrated schematically as a microprocessor 30 that receives instructions from a host device, which is typically a computer, such as a personal computer or a computer aided drafting (CAD) computer system (not shown). The printer controller 30 may also operate in response to user inputs provided through a key-pad and status display portion 32, located on the exterior of the casing 24.

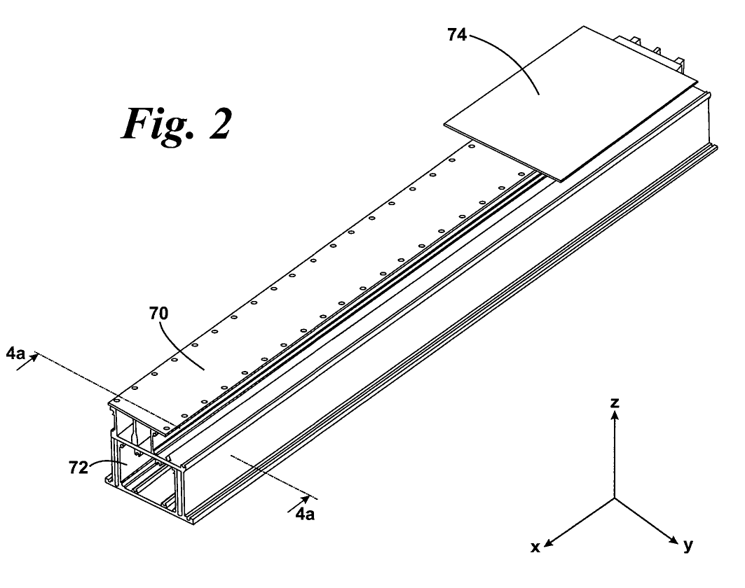

A carriage guide rod 36 is mounted to the chassis 22 and defines a scanning axis 38, slideably supporting an inkjet carriage 40 for travel back and forth across the print zone 35. In the print zone 35, the print media, which may be paper or any other suitable type of sheet material (such as, poster board, fabric, transparencies, Mylar™ and the like) is supported by a platen, shown in FIG. 2. The media sheet receives ink from one or more inkjet cartridge, often called “pens” by those in the art, mounted on the carriage 40. In the printer 20 there are six cartridges, including a black ink cartridge 50, an enlarged view of which is shown in FIG. 1, and five monochrome colour ink cartridges 51 to 55. The cartridges 51 to 55 are each arranged to print one of the following colour inks: cyan; magenta; yellow; light cyan; and, light magenta.

The illustrated pens 50 to 55 each have a printhead (of which only printhead 60 of the pen 50 is illustrated in the figure) which has an orifice plate with a plurality of nozzles formed therethrough in a manner well known to those skilled in the art The pens are arranged to selectively eject ink to form an image on the print media 34 in the print zone 35. In the present embodiment, the print media may be roll fed or individually cut sheets. In the present embodiment, the printheads are thermal inkjet printheads, although other types of printheads may be used, such as piezoelectric printheads.

The illustrated printer 20 uses an “off-axis” ink delivery system, having main stationary reservoirs (not shown) for each ink colour located in an ink supply region 58. In this off-axis system, the pens 50-55 may be replenished by ink conveyed through a conventional flexible tubing system (not shown) from the stationary main reservoirs. In this manner, only a small ink supply is propelled by carriage 40 across the print zone 35, which is located “off-axis” from the path of printhead travel.

The printer 20 also includes a conventional carriage positioning mechanism (not shown) that determines the position of the carriage assembly 40 along the scan axis 38. The carriage positioning mechanism includes a conventional carriage drive motor (not shown) that may be used to propel the carriage 40 in response to a control signal received from the controller 30 in a positive or a negative direction along the guide rod 36.

The printer 20 also includes a conventional print media handling system (not shown) to advance a sheet of print media 34 through the print zone 35. Thus, the carriage position in the X-axis and the position of the print media in the Y-axis is output to the print controller 30. In this manner, the print controller 30 may generate control signals causing the carriage assembly 40 to be moved in the X-axis and the print media to be moved in the Y-axis, such that the pens may print ink at any desired location on the printing area of the print medium.

The vacuum hold down system of the present embodiment will now be described. FIG. 2 shows a perspective view of the platen 70 of the printer 20. As can be seen from the figure, the platen 70 is arranged along the X-axis of the printer 20. In the present embodiment, any conventional type of platen may be employed. However, in the present example, the platen 70 is manufactured from machined aluminium and has a length of approximately 100 cm (≈40 inches) in the X-axis and approximately 25 cm (≈10 inches) in the Y-axis.

As can be seen in the figure, the platen is supported on a vacuum beam 72, the structure and function of which will be described below. In turn, the platen is arranged to support print media that is to be, or is being printed upon. As is well understood in the art, it is preferable that the platen surface is sufficiently smooth and flat to allow print media to be accurately printed on and fed across the platen surface in the media feed direction (Y-axis). A sheet of print media 74, which is supported in a printing position on the platen 70, is also shown in the figure. As is conventional, in this example one edge of the sheet is aligned with one end of the platen. In this example, the sheet 74 is a standard size (DIN A4) and is in a landscape orientation on the platen. Thus, in the present example the sheet 74 only covers a small proportion of the platen surface.

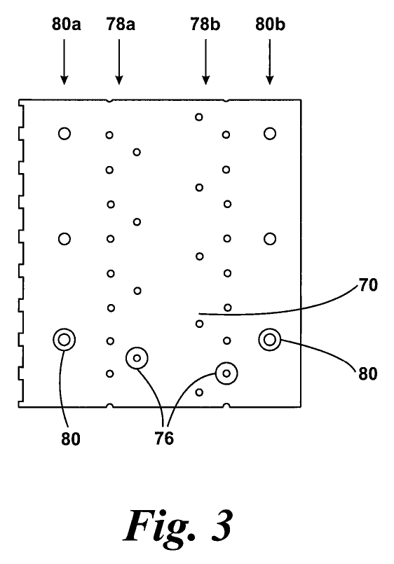

Referring now to FIG. 3, a scrap plan view of the platen 70 is shown. As can be seen from the figure, the platen has a series of platen holes 76 extending through its thickness (i.e. the Z-axis direction, as shown in FIG. 2). The platen holes 76 may be conventional and may be manufactured in a conventional manner. The platen holes 76 ensure that in use, the upper surface of the platen is in fluid communication with a vacuum chamber or vacuum guide located below the platen. Thus, in use, a vacuum force may be exerted on a sheet of print media supported on the platen, as will be described in more detail below. In the present embodiment, the platen holes 76 are arranged in two rows 78a and 78b, arranged parallel to the length of the platen (i.e. the X-axis direction, as shown in FIG. 2). In the present embodiment, the platen holes 76 are laid out in a triangular pattern within each row 78a and 78b and the size and distribution of the platen holes along the length of the platen in each row 78a and 78b is uniform. However, the required size, number and distribution of the platen holes will depend on various operational factors and may be determined experimentally in a conventional manner.

Also shown in the figure are a number of location holes 80, with which the platen 70 is mounted to the vacuum beam 72 using conventional screws. The location holes 80 are arranged in two further rows 80a and 80b, again parallel to the length of the platen. The location holes 80 are also distributed uniformly along the length of the platen.

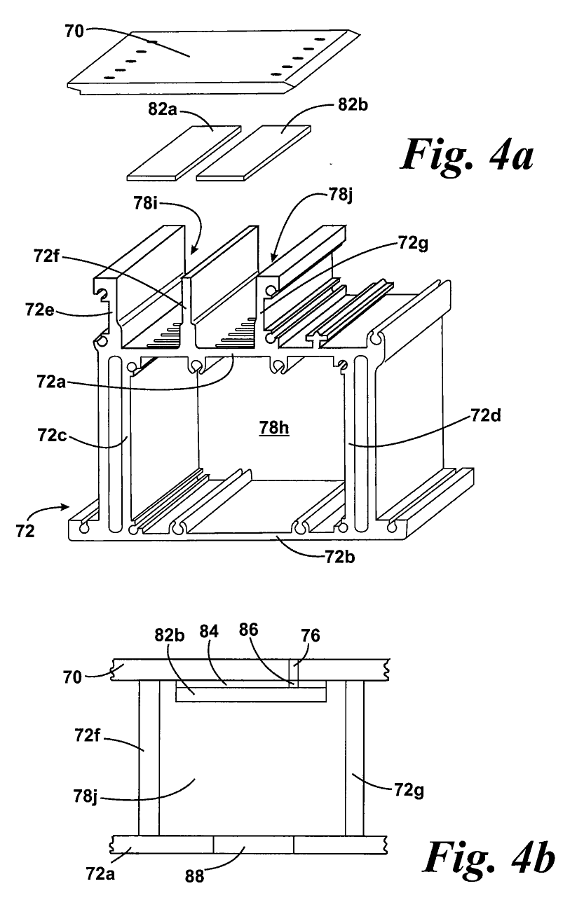

Referring now to FIGS. 4a and 4b, the structure of the vacuum beam 72 the hold down assembly of the present embodiment will now be described. FIG. 4a is a partial, exploded view of the platen 70 and vacuum beam 72 viewed along lines 4a-4a shown in FIG. 2.

As can be seen from the figure, the vacuum beam 72 comprises upper and lower walls 72a and 72b and left and right walls 72c and 72d, which enclose a central hollow space. This is the principal vacuum guide 78h of the vacuum beam. Upstanding from the upper wall 72a are three further walls 72e, 72f and 72g. The vacuum beam 72 is manufactured as an aluminium extrusion, however, any suitable material and manufacturing process may instead be used.

As has been stated above, the platen 70 is mounted on the vacuum beam 72 using conventional screws, which pass through the location holes 80. These screws locate in the upper surfaces of walls 72e and 72g of the vacuum beam. Thus, when the platen is mounted in position on the vacuum beam, two further two hollow spaces are created; thus, forming two secondary vacuum guides 78i and 78j. The two secondary vacuum guides both extend the length of the print platen/vacuum beam assembly. The first secondary vacuum guide 78i is bordered by the platen and the walls 72a, 72e and 72f of the vacuum beam; and, the second secondary vacuum guide 78j is bordered by the platen and the walls 72a, 72f and 72g of the vacuum beam. In the present embodiment, when the platen is assembled with the vacuum beam, the location holes 80, unlike the platen holes 76, do not permit fluid communication between the upper and lower sides of the platen 72.

Also shown in FIG. 4a are two flow restraints 82a and 82b. In the present embodiment, the flow restraints are manufactured from sheets of Porex™, available from Porex Corporation, Porous Products Group Headquarters, 500 Bohannon Road, Fairbum, Ga. 30213, US. Each sheet is bonded to the underside of the platen. The flow restraints 82a and 82b are sized such that when correctly positioned on the underside of the platen, they completely cover each of the platen holes in the corresponding rows 78a, 78b of platen holes. Thus, in the present embodiment, the flow restraints 82a and 82b extend in the X-axis approximately the entire length of the secondary vacuum guides.

Thus, in use, when air is drawn from the upper surface of the platen into either of the secondary vacuum guides 78i or 78j via the corresponding row of platen holes 78a or 78b, the air passes through the thickness (in the Z-axis) of the flow restraints. In this manner, as will be described in more detail below, the impedance imparted by the flow restraints to the vacuum flow may be accurately controlled.

In the present embodiment, the flow restraints are bonded to the lower surface of the platen using conventional double-sided adhesive tape 84 (shown in FIG. 4b). However, in order to ensure that the adhesive tape does not impede the vacuum flow, from the platen holes to the adjacent flow restraint 82a/82b, holes are cut in the adhesive tape in locations corresponding to the platen holes. This may be done prior to bonding the adhesive tape to the platen. This is illustrated in FIG. 4b, which illustrates a partial, simplified cross sectional view of the vacuum beam assembly shown in FIG. 4a when assembled. Adjacent to the illustrated platen hole 76 is a hole 86 in the adhesive tape 84. The size and location of the hole 86 in the adhesive tape 84 is, in the present embodiment, selected to ensure that the presence of the adhesive tape does not significantly affect the impedance to the vacuum flow through the platen and flow restraint assembly. Although only one platen hole is illustrated in the figure, the same arrangement of communicating holes in the platen and the adhesive tape is employed for all holes platen holes in the present embodiment. The skilled reader will appreciate that other suitable methods of securing the flow restraints in place may instead be used in other embodiments of the invention. For example, the flow restraints may be secured in place using conventional mechanical arrangements; such as ties or clips.

Along the length of the upper wall 72a of the vacuum beam between walls 72e and 72f and between walls 72f and 72g a number of large holes 88 are machined in a conventional manner. This is most clearly illustrated in FIG. 4b. These holes permit very low impedance fluid communication between the two secondary vacuum guides 78i, 78j and the principal vacuum guide 78h.

Although not shown in the figures for the sake of clarity, both ends of each of the secondary vacuum guides, together with a first end of the principal vacuum guide are sealed in a conventional manner. The second end of the principal vacuum guide is connected to a conventional fan (not shown), or other suitable device for creating a flow of air (vacuum flow). In this manner, a partial vacuum may be generated in the in the vacuum beam, causing a corresponding vacuum force to act on print media located on the platen, which holds the print media to the platen surface.

In this manner, when the fan is activated, air is drawn from the upper surface of the platen into either or both of the two secondary vacuum guides. In passing into the secondary vacuum guides, the air passes through a given platen hole, followed by the corresponding hole in the adhesive tape and then through the (thickness in the Z-axis) of the corresponding flow restraint. From the secondary vacuum guides, air flows into the primary vacuum guide, via machined holes 88, and is then evacuated from the primary vacuum guide and expelled into the atmosphere.

As the skilled person will understand, the benefit in the present embodiment of having two secondary vacuum guides, which are partially isolated from each other by the wall 72f, is to further isolate the effect of the two rows of platen holes from each other. That is to say, that when a sheet of print media partially covers the platen in the media feed direction (Y-axis), for example when it enters or leaves the print zone, and only one of the rows or platen holes are covered, the presence of the wall 78f of the vacuum beam, reduces the extent to which air entering the vacuum beam via the uncovered holes may reduce the vacuum force exerted by the covered holes on the sheet of print medium. As the skilled reader will understand, the number of secondary vacuum guides required will vary dependent upon various factors, such as the width of the platen in the media feed direction, and may be determined experimentally. However, it will also be understood that the present invention may be implemented without secondary vacuum guides.

Returning now to FIG. 2, in the area in which the sheet of print media 74 covers the platen holes, the impedance to the vacuum flow is composed of three principal impedances acting in series: firstly, the impedance of the print media, Z_{P}; secondly, the impedance of the platen holes, Z_{H} (in the present explanation, the impedance of the platen holes Z_{H} includes that impedance of the platen holes and the much less significant impedance caused by the holes in the adhesive tape); and thirdly, the impedance of the flow restraint Z_{FR}.

In the present embodiment, the characteristics of the flow restraints are selected such that the impedance of the flow restraints Z_{FR} is significantly lower (for example two or more orders of magnitude lower) than that of normal print media, Z_{P} and at the same time significantly higher than that of platen holes, Z_{H}. In the present embodiment, the impedance of the flow restraints Z_{FR} is approximately an order of magnitude (i.e. ten times) higher than the impedance of platen holes, Z_{H}. The impedance of a porous material such as Porex™ is determined partly by its porosity and partly by its thickness in the direction of vacuum flow; that is in the Z-direction in the present example. In the present embodiment the flow restraints have a thickness in the Z-direction of 3 mm and have a pore size of 60-90 μm in diameter. It will be appreciated that the required impedance for different systems will vary and may in practice be determined experimentally for a given system.

Thus, the equivalent impedance Z_{EQ1} of the series impedances of the print media, platen holes and the flow restraint is approximately equal to that of the print media, Z_{P}.
Z_{EQ1}=Z_{P}+Z_{H}+Z_{FR}≈Z_{P}

This means that the presence of the flow restraint does not significantly increase the impedance to the vacuum flow in regions in which print media is fully covering platen holes. Consequently, in areas where print media covers the platen holes in the system of the present embodiment, the print media experiences a hold down vacuum force that is not significantly less than the vacuum force that it would experience if there were no flow restraint present in those areas. In practice, where normal print media, such as paper, is fully covering the platen holes, there is substantially no airflow through those platen holes. This is due to the very high impedance Z_{P} to air-flow which print media has, which acts to substantially seal those holes.

In the areas shown in FIG. 2 in which the sheet of print media 74 does not cover the platen holes, the impedance to the vacuum flow is composed of the series impedances of the platen hole, Z_{H} (again Including the impedance element caused by the holes in the adhesive tape) and of the flow restraint Z_{FR}. Since the impedance of the flow restraint Z_{FR} in the present embodiment is approximately an order of magnitude (i.e. ten times) higher than that of the platen holes, Z_{H} the equivalent impedance Z_{EQ2} of the series impedances of the platen holes and the flow restraint is approximately equal to that of the flow restraint Z_{FR}.
Z_{EQ2}=Z_{H}+Z_{FR}≈Z_{FR}

This means that where a platen hole in the system of the present embodiment is exposed, the vacuum flow through that hole will experience an impedance of Z_{FR}+Z_{H}. This is in contrast to an impedance of Z_{H} only in the case of an exposed hole with no associated flow restraint, as might be found in a prior art printing device.

Since the vacuum flow through the exposed platen hole is inversely proportional to the experienced impedance, it will be understood that the vacuum flow through an exposed platen hole in the present embodiment is greatly reduced relative to the vacuum flow through a corresponding exposed platen hole in a prior art device with no associated flow restraint It may be seen that the reduced flow is approximately equal to Z_{H}/(Z_{FR}+Z_{H}). This is approximately equal to Z_{H}/Z_{FR}, which in the case of the present example is approximately equal to 1/10 of the flow which would be expected where no flow restraint is present.

This reduction in vacuum flow through exposed platen holes ensures that the partial vacuum in the vacuum beam remains higher than would otherwise be the case. Therefore, the vacuum force acting on a sheet of print medium is also higher than would otherwise be the case.

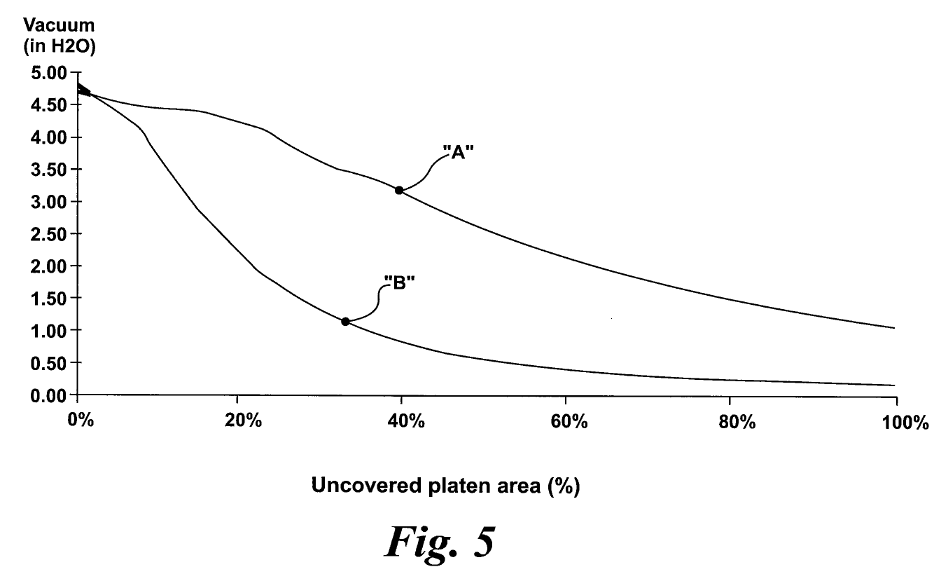

This is illustrated in FIG. 5, which shows the measured relationship between average vacuum pressure (measured in inches of water) acting on a sheet of print media and the percentage of the platen that remains uncovered by the sheet Line “A” shows this relationship for the present embodiment of the invention. Line “B” shows this relationship for a corresponding prior art hold down system. As can be seen from the figure, the maximum achievable vacuum level (where the platen is fully covered) is substantially the same in each case. Thus, the presence of the flow restraints according to the present embodiment does not significantly reduce the maximum achievable vacuum level.

In the case of the prior art system, as illustrated by Line “B”, the average vacuum pressure acting on a sheet of print media falls rapidly as the percentage of uncovered platen area increases from 0%. This means that the hold down system corresponding to line “B” becomes rapidly less efficient as the size of the sheet used is reduced relative to the size of the platen. However, the average vacuum pressure acting on a sheet in the embodiment of the invention, as illustrated by line “A”, decreases much less rapidly as the percentage of uncovered platen area increases from 0%. Thus, the hold down system of the present embodiment is significantly more efficient than the prior art system when part of the platen is exposed. For, example, where 20% of the platen is exposed, the average vacuum pressure acting on a sheet indicated by line “A” is approximately 4.25 inches of H₂0, or 108 mm of H₂0, whereas the corresponding average vacuum pressure indicated by line “B” is approximately 2.25 inches of H₂0, or 58 mm. of H₂0; i.e. the average vacuum pressure indicated by line “A” is approximately 1.9 times that indicated by line “B”.

As can be seen from the figure, as the proportion of the platen that is uncovered increases, the relative efficiency of the embodiment of the invention increases relative to the prior art system. For example, where 80% of the platen is exposed, the average vacuum pressure acting on a sheet indicated by line “A” is approximately 1.50 inches of H₂0, or 38 mm of H₂0, whereas the corresponding average vacuum pressure indicated by line “B” is approximately 0.25 inches of H₂O, or 6 mm of H₂O. This means that where 80% of the platen is exposed the average vacuum pressure indicated by line “A” is approximately 6.0 times that indicated by line “B”.

The relationship between the impedance of the flow restraints of the present embodiment, the uncovered platen area and the vacuum flow is shown in the following equation: where V is the vacuum pressure in the vacuum guide; p is the density of the air; K_{TOT} is the impedance to the vacuum flow through the combination of the platen holes and flow restraints relative to the impedance to the vacuum flow through the platen holes alone; Qᵤ is the vacuum flow through the uncovered area of the platen; and, Aᵤ is the uncovered or exposed platen area.

$$\frac{V}{P} = {\frac{{K}_{TOT}}{2} [ \frac{{Q}_{u}}{{A}_{u}} ]}^{2}$$

From this equation, it can be seen that the internal vacuum pressure will vary in proportion with the total impedance K_{TOT}. Thus by increasing the total impedance value, the internal vacuum pressure may be made to rise. By reducing the impedance value of the flow restraints to zero, the value of the K_{TOT} becomes equal to the value of the impedance of the platen holes; i.e. unity. Thus, it can be seen that any positive value impedance for the flow restraints may be used to increase the value of K_{TOT} and so to increase the internal vacuum pressure of the vacuum guide. However, the value of the vacuum flow Qᵤ and the exposed platen area Aᵤ vary with the K_{TOT} in an inverse square and a square relationship respectively. It will thus be apparent to the skilled reader that the desired K value may be arrived at for a given operational set up.

As has been stated above, for the preferred embodiment of the invention, a preferred value of approximately 10 for K_{TOT} was used. However, values of between 1 and 20 were all found to provide significant advantages to the functioning of the hold down apparatus of the present embodiment.

Thus, the skilled read will understand that the use of flow restraints as described in this embodiment represents an efficient and cost effective method of improving the performance of a vacuum hold down system.

The skilled reader will appreciate that although in this embodiment the flow restraints were described as being bonded to the underside of the platen, in other embodiments this need not be the case; i.e. one or more flow restraints may be used that are located in other locations relative to the platen. The positions of such a flow restraint may be further from the upper surface of the platen, with any suitable channel or channels allowing fluid communication between the flow restraint and the upper surface of the platen. However, the skilled reader will appreciate that this will have the tendency of causing the impedance to the vacuum flow between the upper surface of the platen and the flow restraint to rise, by virtue of the additional channel or channels. In turn, this may cause the maximum achievable vacuum pressure acting on a media sheet to fall for a given operational set up. However, in one particular embodiment of the invention, the impedance to the vacuum flow caused by structure located between the upper surface of the platen and the flow restraint may be reduced by locating the flow restraint material at least partly inside the individual platen holes in the platen. In this embodiment, the flow restraint material may be located flush with or slightly below the upper surface of the platen. The skilled reader will appreciate that the flow restraint material may be bonded in place in individual platen holes. Alternatively, it may be merely mechanically held in place using suitably shaped platen holes, for example.

### Second Embodiment

The second embodiment fulfills substantially the same function as described with reference to the first embodiment and employs substantially the same apparatus. Therefore, like functions, structures and processes will not be described further in detail.

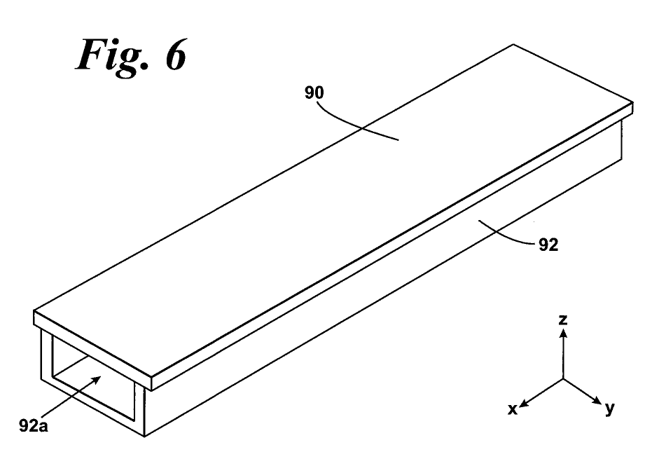

Referring now to FIG. 6, a perspective view of a platen 90 and vacuum beam 92 according to the second embodiment of the invention is shown. In the second embodiment, the platen 90 and vacuum beam 92 may form part of a printer such as the printer 20 described above, which will not be further described.

The vacuum beam 92 in the present embodiment serves substantially the same function as the vacuum beam 72 described in the first embodiment In the present embodiment, for the sake of simplicity of description, the vacuum beam 92 is illustrated as having a single vacuum guide 92a instead of the primary and two secondary vacuum guides described with reference to the vacuum beam 72. However, the skilled reader will appreciate that the vacuum beam of the second embodiment may similarly be provided with further vacuum guides.

In the present embodiment, the platen 90 is formed from a single piece of Porex™. Thus, in the present embodiment, the Porex™ platen 90 fulfills the functions of both the platen and the flow restraint described above with respect to the first embodiment In this way, the platen 90 supports the print media during a printing, operation, as well as transmitting the vacuum force to the supported print media and introducing an impedance to the vacuum flow. It will be appreciated by the skilled reader that the platen 90 may be conventionally mounted on a supporting space frame or wire mesh for example (not shown). Such a frame or mesh may form part of the vacuum beam 92, for example. This may be used to ensure that the platen 90 is maintained within the desired positional and flatness tolerances. The platen 92 may be secured relative to the vacuum beam 92 using conventional mechanical is arrangements, such as ties or clips.

In the present embodiment, the Porex™ material making up the platen 90 may have a pore size of 60-90 μm in diameter. However, as was the case in the first embodiment, other pore sizes may also be used. The X and Y dimensions of the platen 90 may be the same as that of a conventional platen such as that described in the first embodiment. The thickness in the Z direction of the platen 90 in the present embodiment is from 3 to 5 mm. Again, however, other thicknesses may be used. In the present embodiment, it may be desirable to use a platen 90 with a thickness in the Z direction slightly greater than that of the flow restraints of the first embodiment. In this manner, the impedance of the platen 90 may be made approximately equal to the combined impedance of the flow restraint and the separate paten holes of an equivalent system according to the first embodiment, should this be required. As was described above, the thickness of the flow restraint and/or the pore size of the Porex™ may be chosen to give a desired impedance value. Again these values may be determined experimentally.

In use, where the platen 90 is not covered by print media the vacuum system draws air through the platen 90 in the Z direction and into the vacuum guide 92a of the vacuum beam 92. The air is then evacuated to the atmosphere, as previously described.

In the areas in which a sheet of print media covers the platen 90, the impedance to the vacuum flow is composed of two principal impedances acting in series. These are the impedance Z_{P} of the print media and the impedance Z_{FR} of the porous platen or flow restraint. This is in contrast to the first embodiment in which the platen holes 78 contributed a further impedance.

As was the case in the first embodiment, the impedance characteristics of the platen 90 are selected so as to be significantly lower (for example two or more orders of magnitude lower) than that of normal print media. The equivalent impedance Z_{EQ3} of the series impedances of the print media and the flow restraint in this case is thus approximately equal to that of the print media, Z_{P}.
Z_{EQ3}=Z_{P}+Z_{FR}≈Z_{P}

Consequently, in areas where print media covers the platen in the system of the present embodiment, the print media experiences a hold down vacuum force that is not significantly less than the vacuum force that it would experience if there were no flow restraint present in those areas.

Due to the absence of separate platen holes 78 in the present embodiment, in the areas in which a sheet of print media does not cover the platen 90 the impedance to the vacuum flow is equal to the impedance of the flow restraint Z_{FR} alone. As was the case in the first embodiment, the impedance of the flow restraint Z_{FR} in the present embodiment is approximately an order of magnitude (i.e. ten times) higher than that of the platen holes that would be required in a prior art system. Therefore, the air flow though areas of the platen not covered by print media may be reduced by a corresponding degree.

It will be understood by the skilled reader that the present embodiment provides a vacuum holddown system with various advantages. By using the flow restraint as the platen, the flow restraint is effectively coterminous with the upper surface of the platen. In this manner, the distance separating the flow restraint from a supported media sheet is greatly reduced or eliminated. As a consequence, any impedance to the vacuum flow that would normally be present between the flow restraint and the supported media sheet, as might be caused by the separate platen holes 78 in the first embodiment for example, may also be greatly reduced or eliminated.

Furthermore, the vacuum pressure which is applied to a sheet in the present embodiment may be very evenly distributed across the area of the sheet, due to the relatively small separation, or tight packing, between adjacent pores in the upper surface of the platen 90. Thus, the maximum achievable vacuum pressure acting on a media sheet in the present embodiment may be increased. This characteristic of the present embodiment may be useful in holding down the edges of a print media sheet This may be independent of the size of the media sheets. In contrast, due to the relatively large separation between conventional platen vacuum ports, it may occur that no or insufficient ports are located at the positions required to adequately hold down the edges of certain sizes of media sheet. As a result, the edges of media sheets may tend to lift off a conventional platen.

Additionally, by using a platen made from flow restraint material, a structurally simple and inexpensive solution may be achieved. It will be understood that very few parts are required and those parts may be of relatively low cost. Furthermore, it will be understood that such an embodiment may be adapted to a great range of applications. The platen size may be freely modified in the X and Y directions. Furthermore, the required impedance may be easily selected by varying the Z dimension of the platen or the pore size, or both.

### Further Embodiments

In the above embodiment numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

The skilled reader will also appreciate that the embodiments of the invention may be modified to implement the invention in certain areas of the platen only. In the case of the first embodiment, flow restraints may be used to impede the vacuum flow of only selected channels through the platen. For example, flow restraints may be used to impede the vacuum flow of 75%, or 50% of the vacuum channels. In certain cases, significant benefit may be obtained whilst using flow restraints to impede the flow of an even smaller proportion of the channels. In the case of the second embodiment, a composite platen may be used which in selected area is formed from a porous material and in other areas is conventional.

Although in the above-described embodiments, the flow restraints were selected such that the maximum attainable vacuum pressure acting on a sheet of print media was not significantly reduced relative to a corresponding prior art system, the skilled reader will realise that need not necessarily be the case. It will be appreciated that in further embodiments of the invention, higher impedance flow restraints may be used. Such flow restraints may have the effect of reducing the maximum attainable vacuum pressure. However, by using such flow restraints, advantages may be realised regarding the relationship between average vacuum pressure acting on a sheet of print media and the percentage of the platen remaining uncovered by the sheet. For example, the average vacuum pressure acting on a sheet that covers only a relatively small proportion of the platen may be relatively increased in such an embodiment This may be desirable in systems where use with relatively small sheets is thought likely to be common. Furthermore, in such a system the reduction in average vacuum pressure as the uncovered platen percentage rises may be more linear. This may make it possible to more easily determined suitable vacuum power requirements with different print media sizes in a variable vacuum power system.

In further embodiments of the invention, variable impedance flow restraint systems may be used. Such systems may employ flow restraints having an impedance that varies along the length, or even width, of the platen. In a simple embodiment of this type, a flow restraint may be employed only along a portion of the length of a platen such as that described in the first embodiment. For example, in the case of a printer that is designed to operate with roll fed print media having a minimum width less that the platen width and aligned with a given end of the platen, no flow restraint may be needed under the portion of the platen where it is normally covered by the minimum size of print media.

Generally print media is registered at one end of the platen, resulting in that end of the platen usually being covered by print medium when in use. The media supporting surface of the platen located increasingly further from the registration end of the platen, is likely to spend more and more time uncovered while the printer is in use. Thus by using a flow restraint that has an impedance that rises with distance from the registration end of the platen, a more efficient hold down system may be obtained. This may particularly be the case in printer devices designed to be used primarily with print media widths that are small relative to the platen width. Such a variable impedance flow restraint may be manufactured by using a flow restraint of fixed porosity and varying its thickness along the platen length. Alternatively, the same effect may be achieved by varying the porosity of the flow restraint A further alternative would be to use a flow restraint composed of various materials of differing porosity.

In the above-described embodiments the flow restraints were described as being manufactured from Porex™. It has been found that Porex™ has a porous or labyrinthine structure that provides good results in the above-described embodiments. However, the skilled reader will appreciate that in other embodiments of the invention other materials and structures having suitable impedance characteristics may instead, or as well, be used. Suitable materials may include foams or other porous substances. Suitable structures may include woven materials or sheets of various types; porous membranes; and, filters, especially of the type suitable for filtering particles from gasses such as air supplies.

In one modification of the first embodiment, the flow restraints may be constructed from a substantially impermeable membrane, such a plastic sheet. In this embodiment, the sheet may be bonded to the underside of the platen using a conventional adhesive or otherwise fixed in a conventional manner. One or more very narrow diameter holes (such as would be made by a pin, for example) may be made through the thickness of the membrane in areas corresponding to the positions of the platen holes. In this manner the flow through each platen hole may be restricted. Such an embodiment allows the working section of the platen holes to be significantly reduced, thus achieving the advantage of reducing vacuum flow through exposed platen holes. It will be understood that the manufacturing of platen holes of an equivalent working section is generally impracticable. In such an embodiment, the vacuum force acting on a sheet of print media may fall, as the percentage of uncovered platen area rises, at a greater rate than is the case with labyrinthine type flow restraints. However, it generally offers significantly improved performance relative to a platen without flow restraints. It may be found that in such an embodiment, the number of platen holes may need to be increased in order to achieve the correct balance between average vacuum pressure acting on a sheet of print media and the vacuum flow through exposed vacuum holes. However, this together with the required diameter of the holes through membrane may be found by experimentation.

It will also be understood that the user may wish to replace the flow restraints, or porous platen of embodiments of the invention after a period of use. This period may be many months if not years of use. However, depending upon the environment in which a printing device according to an embodiment of the present invention is used, the flow restraints or platen may eventually become partially blocked. Thus, in embodiments of the invention, replacement sets of flow restraints for a given hold down system or printer or replacement platens may be sold independently as supplies.

Although in the above-described embodiment the platen was described as being a stationary holding surface, the skilled reader will appreciate that in other embodiments of the invention, the platen may be a moving surface such as a rotating “drum”, the surface of which is used to support a print medium.

1-23. (canceled)

24. A porous platen for use in a hardcopy apparatus.

25. A platen according to claim 24, wherein the platen is made from a foam or equivalent material.

26. A servicing kit comprising at least one flow restraint according to claim 1.

27. A method of manufacturing a vacuum hold down apparatus, for use in a hard copy device, the apparatus comprising a platen having a first and second surfaces, with a plurality of vacuum channels allowing fluid communication between the surfaces, the first surface being arranged to support a sheet of print media thereon, comprising the step of:
bonding or otherwise fixing one or more flow restraints adjacent the second surface of the platen.

28. A method according to claim 27, wherein the one or more flow restraints comprise one or more sheets of porous material arranged to cover a plurality of the channels.

29. A method according to claim 27, wherein the one or more flow restraints are arranged to be located in one or more of the vacuum channels.

30-31. (canceled)
